(19) United States
(12) Patent Application Publication
(10) Pub. No.: US 2010/0162790 A1
(43) Pub. Date: Jul. 1, 2010

(54) SENSOR ELEMENT FOR DETERMINING THE CONCENTRATION OF AN OXIDIZABLE GAS COMPONENT IN A MEASURING GAS

(76) Inventors: Joerg Ziegler, Rutesheim (DE); Mario Roessler, Ceske Budejovice (CZ); Bernd Schumann, Ruteshein (DE); Berndt Cramer, Leonberg (DE)

Correspondence Address: KENYON & KENYON LLP, ONE BROADWAY, NEW YORK, NY, 10004, US

(21) Appl. No.: 12/305,610

(22) PCT Filed: Dec. 12, 2007
(86) PCT No.: PCT/EP07/63772

§ 371 Date: Oct. 2, 2009

(30) Foreign Application Priority Data
Dec. 29, 2006 (DE) 102006062058.5

(51) Int. Cl. G01M 15/10

(52) U.S. Cl. 73/23.31

(57) ABSTRACT

A sensor element is provided for a gas sensor for determining the concentration of an oxidizable gas component, especially ammonia, in a measuring gas, in particular in the exhaust gas of an internal combustion engine, the sensor element having at least one measuring electrode acted upon by the measuring gas. To eliminate the sensitivity of the sensor element with respect to nitrogen oxides, measuring-gas volumes acting on the measuring electrode are routed through a means for absorbing nitrogen oxides in the form of a regenerative nitrogen-oxide trap.

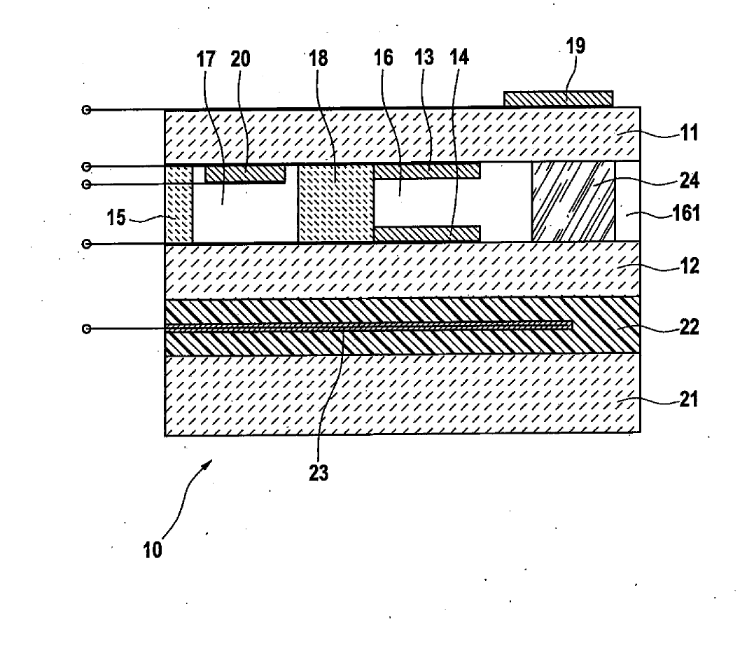

### FIELD OF THE INVENTION

The present invention relates to a sensor element for determining the concentration of an oxidizable gas component, specifically ammonia, in a measuring gas, in particular in the exhaust gas of an internal combustion engine.

### BACKGROUND INFORMATION

Under operating conditions that correspond to an air-fuel ratio of λ=1, nitrogen oxides contained in the exhaust gas for the most part are converted into nitrogen, water and carbon dioxide in the exhaust catalytic converter by reducing components likewise present in the exhaust gas, such as hydrocarbons, for example. In lean operation with an excess-air factor of δ>1, however, the quantity of reducing components in the exhaust gas is insufficient so that excess nitrogen oxides must be removed in some other manner. One conventional method is the selective charging of ammonia or ammonia-producing substances into the exhaust-gas stream. This is done in the direction of the exhaust gas, in front of an additional catalytic converter at whose surface the reaction of the nitrogen oxides with ammonia to nitrogen and water takes place. To be able to apply this conventional SCR method (selective catalytic reduction method) effectively, the charged ammonia quantity must be adapted to the excess nitrogen oxides as precisely as possible. For this, gas sensors that are sensitive to and selective for ammonia are used, by which the ammonia content in the exhaust gas is able to be determined.

One conventional sensor element for a gas sensor for determining the concentration of hydrogen present in a gas mixture or a hydrogen-containing gas component, preferably ammonia (NH₃), (DE 199 63 008 A1) has a measuring electrode exposed to a gas mixture, and a reference electrode exposed to a reference gas, which are disposed on sides of a proton-conducting solid electrolyte layer facing away from one another. A plurality of solid electrolyte layers are laminated together to form a ceramic body, the reference electrode lying inside a reference gas chamber formed between the solid electrolyte layers. All proton-conducting solid electrolyte layers are made of, for example, cerium oxide (CeO₂) with dopings of earth alkali oxides such as calcium oxide (CAO), strontium oxide (SrO), barium oxide (BaO). The ammonia-sensitive measuring electrode is made from a catalytically inactive material such as gold, palladium, silver, or rhutenium. The reference electrode consists of a catalytically active material, e.g., platinum. An electric resistor heater embedded in an electric insulation is disposed inside the ceramic body. The resistor heater is used to heat the sensor element to the required operating temperature of approximately 500° C. To determine the ammonia content in the gas mixture, the measuring and reference electrodes are operated as what is referred to as a Nernst cell, the electromotive force (EMF) produced at the measuring and reference electrode as a result of the different concentrations of hydrogen and protons being measured as voltage. The magnitude of the voltage is a measure for the hydrogen or proton concentration at the measuring electrode and thus a measure for the ammonia content in the measuring gas. Because of the use of a proton-conducting solid electrolyte, the sensor element exhibits virtually no cross sensitivity with regard to oxygen-containing compounds such as the nitrogen oxides.

Another conventional sensor element for a gas sensor for determining the concentration of ammonia in a gas mixture (EP 1 452 860 A1) has at least one auxiliary electrode and at least one measuring electrode disposed downstream in the flow direction of the gas mixture, which are in direct contact with the gas mixture. With the aid of the measuring electrode, a signal for determining the ammonia concentration is generated at least intermittently. To this end, a potential is applied to the auxiliary electrode at which only oxygen and/or nitrogen oxides are reduced and removed from the gas mixture. A potential at which ammonia present in the gas mixture is oxidized is applied at the measuring electrode. The pump current from the measuring electrode to the reference electrode is utilized as measure for the concentration of ammonia in the gas mixture. Using a second auxiliary electrode disposed between the auxiliary electrode and the measuring electrode, ammonia still present in the gas mixture is oxidized to corresponding nitrogen oxides, especially nitrogen monoxide. At the same time, the oxygen concentration still present in the gas mixture is reduced further, and hydrogen contained in the gas mixture is oxidized. In this manner, the measuring electrode exhibits low sensitivity to the hydrogen concentration of the gas mixture to be measured.

### SUMMARY

An example sensor element according to the present invention may have the advantage that it does not reduce the sensitivity of the measuring electrodes or the measuring path itself with regard to oxygen compounds, especially nitrogen oxides, but that the interfering nitrogen oxides are removed from the exhaust gas before the measuring gas reaches the measuring electrode or the measuring path. This results in complete insensitivity of the sensor element to nitrogen oxides, which is only dependent upon the quality of the nitrogen oxide absorption in the measuring gas volume reaching the measuring electrode. Elimination of the nitrogen oxides takes place by storage in the preferably barium- or barium-oxide-containing absorbing agent in the form of barium nitrate (Ba(NO₃)₂). The absorbing agent may be regenerated by different methods.

According to one advantageous specific embodiment of the present invention, a regenerative nitrogen oxide trap made of porous material having a barium-containing storage component and preferably an additional noble metal component is provided for absorbing oxidizing nitrogen monoxide (NO) to nitrogen dioxide (NO₂) since the latter is able to be stored much more easily. The barium in the storage component is present in the form of barium oxide (BaO) or barium carbonate (BaCO₃), which is converted into barium nitrate (Ba(NO₃))₂ for storing the nitrogen oxides.

According to one advantageous specific embodiment of the present invention, to regenerate the nitrogen oxide trap, the latter is exposed to a temperature that is greater than 500° C. At this temperature, the barium nitrate is broken down again to barium oxide so that the nitrogen oxide trap is fully absorptive again.

According to an alternative specific embodiment of the present invention, to regenerate the nitrogen oxide trap, a rich gas is produced in the region between the nitrogen oxide trap and the measuring electrode in that a breakdown of the water and the carbon dioxide contained in the measuring gas, into hydrogen and carbon monoxide, is induced by applying an appropriate voltage potential to the measuring electrode. The carbon monoxide reacts with the stored barium nitrate and converts it to barium oxide and/or barium carbonate. The released, negatively charged oxygen ions are carried away from the measuring electrode due to the prevailing voltage potential.

According to an advantageous specific embodiment of the present invention, the measuring electrode is disposed in a measuring chamber having a measuring-gas entry, and the nitrogen oxide trap is disposed in the measuring-gas entry. An electric heater setting the operating temperature of the measuring electrodes is situated in such a way with respect to the measuring chamber and the measuring-gas entry that at the operating temperature at the measuring electrode, the nitrogen oxide trap situated in the measuring-gas entry has an optimal storage temperature, which preferably lies between 200° C. to 400° C.

### BRIEF DESCRIPTION OF THE DRAWING

The present invention is explained in greater detail below on the basis of an exemplary embodiment shown in the FIGURE. The FIGURE shows a schematic illustration of a longitudinal section of a sensor element for a gas sensor for determining the ammonia content in a measuring gas.

### DETAILED DESCRIPTION OF EXAMPLE EMBODIMENTS

The sensor element, shown in a sectional longitudinal view in the drawing, for a gas sensor for determining the concentration of ammonia as one example for an oxidizable gas component in a measuring gas, preferably in the exhaust gas of an internal combustion engine, has a planar ceramic body 10, which is made up of a multitude of ceramic foils which form an oxygen ion-conducting solid electrolyte layer from a solid electrolyte material such as, for example, yttrium-stabilized or partially yttrium-stabilized zirconium dioxide (ZrO₂). The integrated form of planar ceramic body 10 is produced by laminating together the ceramic foils printed over with functional layers and subsequently sintering the laminated structure in a manner known per se. An outer electrode 19 and a first measuring electrode 13 are applied on a first, upper ceramic foil 11 on surfaces facing away from each other, outer electrode 19 being directly exposed to the measuring gas. A second measuring electrode 14, which lies across from first measuring electrode 13, is mounted on the upper foil surface of a second ceramic foil 12 facing toward ceramic foil 11. Disposed between first and second ceramic foil 11, 12 is a layer 15 made of solid electrolyte material, in which a measuring chamber 16 is formed on the one hand, and a reference-gas channel 17 on the other.

Measuring chamber 16 and reference-gas channel 17 are separated from one another in gas-tight manner by a dividing wall 18. Measuring chamber 16 has a measuring-gas entry 161 for the measuring gas surrounding ceramic body 10 and accommodates the two measuring electrodes 13, 14. Measuring electrodes 13, 14 are ceramic or metallic mixed potential electrodes, which are catalytically inactive. The metallic mixed potential electrodes are made from, e.g., a platinum/gold alloy, but alloys containing palladium, silver or ruthenium are suitable as well. As an alternative, one of measuring electrodes 13, 14 may be implemented as pure platinum electrode, which thus is catalytically active. Reference-gas channel 17 preferably terminates in the atmosphere, so that a reference electrode 20 disposed on the surface of first ceramic foil 11 (alternatively, on the surface of second ceramic foil 12) is acted upon by ambient air. An electric heater 23, which is embedded in an electric insulation 22 and used to heat the sensor element to operating temperature, is situated between second ceramic foil 12 and a third ceramic foil 21. A regenerative nitrogen oxide trap 24 made from porous material is disposed in measuring-gas entry 161, through which the measuring-gas volume entering measuring chamber 16 via measuring-gas entry 161 is flowing. The nitrogen oxides contained in the measuring-gas volume are absorbed in nitrogen oxide trap 24. To this end, the porous material of nitrogen oxide trap 24 has a barium-containing storage component and a noble metal component. The latter is used as catalytic converter for the oxidation of nitrogen monoxide (NO) since the nitrogen dioxide produced in the oxidation is able to be absorbed more optimally by the storage component. Metal oxides or mixtures of metal oxides, especially oxides of alkali, alkaline earth or rare-earth metals, are used for the storage component, barium oxide and also barium carbonate preferably being used. Platinum, palladium, rhodium or mixtures or alloys thereof may be used for the noble metal component. Nitrogen oxide trap 24 formed in this manner reaches its optimum storage capacity in a temperature range between 200° C. and 400° C. To be able to set the corresponding temperature at nitrogen-oxide trap 24, electric heater 23 is placed inside ceramic body 10 in such a way that, for one, it sets an operating temperature of approx. 500° C. inside measuring chamber 16 and, for another, it sets the optimum storage temperature of nitrogen-oxide trap 24 inside measuring-gas entry 161. The nitrogen oxide contained in the measuring-gas volume flowing toward measuring chamber 16 is stored in nitrogen oxide trap 24 in that the barium oxide or the barium carbonate is converted into barium nitrate (Ba(NO₃)₂) in nitrogen oxide trap 24. Apart from ammonia, the described gas sensor may be also be used for determining the concentration of other oxidizable gas components in the measuring gas. For example, the concentration of hydrogen or hydrocarbon may be measured as well.

To measure the ammonia concentration in the measuring gas, a voltage, which lies between 0 and 1V, for example, is applied to the two measuring electrodes 13, 14. The current and/or the voltage between electrodes 13, 14 is analyzed as measure for the ammonia concentration in the measuring gas.

As an alternative, one of the two measuring electrodes 13, 14 may be omitted, and the remaining measuring electrode 13 or 14 and reference electrode 20 are able to be utilized to measure the ammonia concentration. In this case, the current or the voltage between reference electrode 20 and measuring electrode 13 is a measure for the ammonia concentration in the measuring gas.

In addition, the oxygen content in the measuring gas may be measured in the conventional manner with the aid of reference electrode 20 and outer electrode 19.

If one dispenses with the option of measuring the oxygen concentration in the measuring gas, then reference electrode 20 and reference-gas channel 17 may be omitted, but the measuring result of the ammonia measurement is able to be improved by taking the oxygen concentration into account.

If the storage capacity of nitrogen-oxide trap 24 is depleted, i.e., the entire available barium oxide or barium carbonate converted into barium nitrate, then nitrogen oxide trap 24 will be regenerated in that nitrogen oxide trap 24 is briefly exposed to a temperature that is greater than 500° C. with the aid of electric heater 23. At this temperature the barium nitrate is broken down into barium oxide.

To regenerate nitrogen oxide trap 24, a rich gas may alternatively be produced in measuring chamber 16 by applying a voltage between one of the two measuring electrodes 13, 14 and outer electrode 19. In this case, water (H₂0) and carbon dioxide (CO₂), which are contained in the measuring-gas volume inside measuring chamber 16, are broken down into carbon monoxide (CO) or hydrogen (H₂) and oxygen, and the free oxygen ions formed by the electron acquisition are pumped out of measuring chamber 16. Rich gas (λ<1), which reacts with the barium nitrate and converts it into BaO or BaCO₃, forms in measuring chamber 16.

To regenerate nitrogen-oxide trap 24, the internal combustion engine may also briefly be brought into a state in which components of H₂ and CO occur in the exhaust gas without a rich gas mixture being present.

1-17. (canceled)

18. A sensor element for a gas sensor for determining a concentration of an oxidizable gas component in a measuring gas, comprising:
at least one measuring electrode acted upon by measuring-gas volumes; and
an absorption component adapted to absorb nitrogen oxides in the measuring-gas volumes acting on the measuring electrode.

19. The sensor as recited in claim 18, wherein the oxidizable gas component is ammonia and the measuring gas is an exhaust gas of an internal combustion engine.

20. The sensor element as recited in claim 18, further comprising:
a component adapted to route the measuring-gas volumes through the absorption component.

21. The sensor element as recited in claim 18, wherein the absorption component includes a regenerative nitrogen oxide trap.

22. The sensor element as recited in claim 21, wherein the nitrogen oxide trap has porous material which includes a barium-containing storage component.

23. The sensor element as recited in claim 22, wherein the storage component includes metal oxides or mixtures of metal oxides.

24. The sensor element as recited in claim 23, wherein the metal oxides or mixtures of metal oxides include at least one of sodium, potassium, alkaline earth metals, barium, rare-earth metals and lanthanum.

25. The sensor element as recited in claim 21, wherein the nitrogen-oxide trap has a catalytically active metal component for the oxidation of nitrogen monoxide, which includes one of platinum, palladium, rhodium or mixtures or alloys thereof.

26. The sensor element as recited in claim 25, wherein the catalytically active metal component is a noble metal component.

27. The sensor element as recited in claim 18, wherein the at least one measuring electrode is at least one of i) made of a catalytically inactive material, which contains one of gold, palladium, silver or ruthenium, and ii) a gold/platinum alloy.

28. The sensor element as recited in claim 21, wherein the nitrogen-oxide trap is briefly exposable to a temperature that is greater than 500° C. for the purpose of regenerating it.

29. The sensor element as recited in claim 21, further comprising:
a component to regenerate the nitrogen-oxide trap and to influence the measuring-gas volume present between the nitrogen-oxide trap and the measuring electrode which produces components of hydrogen and carbon monoxide in the measuring-gas volume.

30. The sensor element as recited in claim 18, wherein the at least one measuring electrode is disposed in a measuring chamber having a measuring-gas entry, the measuring chamber being at least partially surrounded by an oxygen-ion-conducting solid electrolyte, and the nitrogen-oxide trap being disposed in the measuring-gas entry.

31. The sensor element as recited in claim 30, further comprising:
an electric heater which sets an operating temperature for the at least one measuring electrode, the electric heater being disposed with respect to the measuring chamber and the measuring-gas entry that at an operating temperature prevailing at the at least one measuring electrode, the nitrogen-oxide trap lies in a range between 200° C. and 400° C.

32. The sensor element as recited in claim 30, wherein the measuring chamber is delimited by an oxygen-ion-conducting solid electrolyte layer on whose side facing away from the measuring chamber an outer electrode is disposed, which is able to be exposed to the measuring gas.

33. The sensor element as recited in claim 32, further comprising:
a component to apply a voltage to the outer electrode and the at least one measuring electrode to regenerate the nitrogen-oxide trap, so that oxygen is pumped out of the measuring chamber.

34. The sensor element as recited in claim 30, further comprising:
a reference electrode situated in a reference-gas channel sealed off from the measuring chamber in a gas-tight manner.

35. The sensor element as recited in claim 30, further comprising:
a second measuring electrode disposed in the measuring chamber; and
a component adapted to apply an electric voltage to the two measuring electrodes, a current or voltage between the measuring electrodes constituting a measure for the concentration of the gas component in the measuring gas.

36. The sensor element as recited in claim 34, further comprising:
a component adapted to apply an electric voltage between the reference electrode and the at least one measuring electrode, and a voltage or current between the reference electrode and the measuring electrode constituting a measure for the concentration of the gas component.

37. The sensor element as recited in claim 34, further comprising:
a component adapted to apply a voltage to the reference electrode and an outer electrode in order to measure oxygen content in the measuring gas, and a voltage potential occurring between the reference electrode and the outer electrode constituting a measure for the oxygen concentration in the measuring gas.
